(19) United States
(12) Patent Application Publication
(10) Pub. No.: US 2026/0238539 A1
(43) Pub. Date: Aug. 13, 2026

(54) TRANSMITTING DATA TO A NETWORK NODE, RECEIVING DATA FROM A NETWORK NODE, AND DETERMINING CONSTELLATION POINTS FOR SIGNAL TRANSMISSION

(71) Applicant: Telefonaktiebolaget LM Ericsson (publ), Stockholm (SE)

(72) Inventors: Naoki ENDO, Hiratuka-shi, Kanagawa (JP); Naoki ISHIKAWA, Yokohama, Kanagawa (JP); Hiroki IIMORI, Hiratuka-shi, Kanagawa (JP); Chandan PRADHAN, Yokohama, Kanagawa (JP); Szabolcs MALOMSOKY, Yokohama, Kanagawa (JP)

(73) Assignee: Telefonaktiebolaget LM Ericsson (publ), Stockholm (SE)

(21) Appl. No.: 19/150,754

(22) PCT Filed: Jan. 25, 2023
(86) PCT No.: PCT/SE2023/050067

§ 371 Date: Jul. 24, 2025

(51) Int. Cl. H04L 27/34; H04B 7/02; H04L 1/06; H04L 5/00

(52) U.S. Cl. CPC H04L 27/3416; H04B 7/02; H04L 1/0618; H04L 5/0044; H04L 5/0048; H04L 27/3483

(57) ABSTRACT

Methods and apparatus are provided. In an example, a method of transmitting data to a network node is provided. The method comprises selecting, based on the data to be transmitted to the network node, one of a plurality of first constellation points on a Grassmannian manifold, wherein the first constellation points comprise a plurality of groups of first constellation points, and a distance between first constellation points in each group is smaller than a distance between groups of first constellation points. The method also comprises transmitting a reference signal symbol sequence associated with the selected first constellation point to the network node.

### TECHNICAL FIELD

Example embodiments of this disclosure relate to transmitting data to a network node and/or receiving data from a network node, such as for example reference signal symbol sequences. Example embodiments also relate to determining constellation points for signal transmission, such as for example constellation points on a Grassmannian manifold.

### BACKGROUND

Demand for wireless communication, such as for example according to the 5th Generation (5G) standard and beyond, has continued to grow, resulting in the fact that under the limited radio spectrum, communication technologies that can achieve high spectral efficiency while reducing computational complexity and energy usage will become more important.

In some examples of wireless communication, channel information (a.k.a. Channel State Information, CSI) is required for a receiver to detect data sequences transmitted from UEs.

The accuracy of CSI impacts the overall performance of data transmission, e.g., spectrum efficiency. In order to obtain the CSI between a base station and a UE, a reference-signal-based training method has been used. In such scenarios, a UE transmits pilot (i.e., reference) symbols known by both transmitter and receiver, based on which the receiver estimates CSI. Although such training methods result in reliable and high accurate channel estimation, the associated pilot overhead leads to degradation in the overall spectrum efficiency.

To reduce the pilot overhead and improve the spectral efficiency, a number of methods have been proposed, such as a pilot-imposed approach that transmits pilot and data simultaneously by simply adding a pilot signal onto the data signal and transmitting its combination within the same time and frequency resource block. However, such a superimposed pilot approach is limited in terms of the channel estimation accuracy.

New Radio (NR) uses CP-OFDM (Cyclic Prefix Orthogonal Frequency Division Multiplexing) in both downlink (DL) (i.e. from a network node, gNB, or base station, to a user equipment or UE) and uplink (UL) (i.e. from UE to gNB). Discrete Fourier Transform (DFT) spread OFDM is also supported in the uplink. In the time domain, NR downlink and uplink are organized into equally sized subframes of 1 ms each. A subframe is further divided into multiple slots of equal duration. The slot length depends on subcarrier spacing. For subcarrier spacing of Δf=15 kHz, there is only one slot per subframe, and each slot consists of 14 OFDM symbols. Data scheduling in NR is typically on a slot basis. An example of NR time-domain structure with 15 kHz subcarrier spacing is shown in FIG. 1 with a 14-symbol slot, where the first two symbols contain physical downlink control channel (PDCCH) and the rest contains a physical shared data channel, either PDSCH (physical downlink shared channel) or PUSCH (physical uplink shared channel).

Different subcarrier spacing values are supported in NR. The supported subcarrier spacing values (also referred to as different numerologies) are given by Δf=(15×24) kHz, where μ={0,1,2,3,4}. Δf=15 kHz is the basic subcarrier spacing. The slot duration at different subcarrier spacings is given by

$$\frac{1}{{2}^{μ}} ms .$$

In the frequency domain, a system bandwidth is divided into resource blocks (RBs), each corresponds to 12 contiguous subcarriers. The RBs are numbered starting with 0 from one end of the system bandwidth. An example of the NR physical time-frequency resource grid is illustrated in FIG. 2, where only one resource block (RB) within a 14-symbol slot is shown. One OFDM subcarrier during one OFDM symbol interval forms one resource element (RE).

In NR Rel-15, uplink data transmission can be dynamically scheduled using PDCCH. A UE first decodes uplink grants in PDCCH and then transmits data over PUSCH based on the decoded control information in the uplink grant such as modulation order, coding rate, uplink resource allocation, etc.

Demodulation Reference Signal (DM-RS) for PUSCH is an UL reference signal that consists of a pseudo-random QPSK sequence for CP-OFDM or low peak to average power ratio (PAPR) sequences for DFT-S-OFDM. DM-RS is used for demodulating of PUSCH such that the receiver (i.e., the gNB) can handle time-varying and frequency-selective channels. DM-RS is confined to the scheduled PUSCH bandwidth and duration.

The mapping of DM-RS to REs is configurable in both frequency and time domain. In the frequency domain, there are two mapping types: type 1 (comb based) or type 2 (non-comb based). In the time-domain, DM-RS can be either single symbol or double symbol, where the latter means that DM-RS is mapped in pairs of two adjacent symbols. Furthermore, a UE can be configured with one, two, three or four single-symbol DM-RS and one or two double-symbol DM-RS. In low-Doppler scenarios, one DM-RS symbol may be sufficient whereas in high-Doppler scenarios, additional DM-RS symbols may be required.

The frequency-domain starting position of DM-RS is the same as the frequency-domain starting position of PUSCH. The time-domain starting position of DM-RS depends on the PUSCH mapping type:
For PUSCH mapping type A (slot-based scheduling), the first DM-RS symbol is in the third or fourth symbol (i.e., symbol 2 or 3) of a slot, configured by higher-layer parameter DM-RS-TypeA-Position in the Master Information Block (MIB) broadcast by the gNB.
For PUSCH mapping type B (non-slot-based scheduling), the first DM-RS symbol of a slot is the same as the first PUSCH symbol of a slot.

DM-RS for PUSCH is Radio Resource Control (RRC) configured through the DM-RS-UplinkConfig Information Element (IE), for PUSCH scheduled by Downlink Control Information (DCI) format 0_1 or DCI format 0_2. DM-RS for PUSCH is configured in RRC according to 3GPP TS 38.331 version 16.1.0.

DM-RS for PUSCH is configurable with respect to:
The DM-RS frequency-domain mapping type (type 1 or type 2), configured by the RRC parameter DM-RS-Type. Type 1 is comb based with 2 code division multiplexed (CDM) groups, whereas type 2 is not comb based with 3 CDM groups. For DFT-S-OFDM, only type 1 is supported. FIG. 3 illustrates the symbol positions of DM-RS symbols in a resource block for the two DM-RS types 1 and 2. Specifically, FIG. 3(a) illustrates DM-RS symbol positions for DM-RS type 1 single symbol; FIG. 3(b) illustrates DM-RS symbol positions for DM-RS type 1 double symbol; FIG. 3(c) illustrates DM-RS symbol positions for DM-RS type 2 single symbol; and FIG. 3(d) illustrates DM-RS symbol positions for DM-RS type 2 double symbol. In these FIGS. 3(a)-(d), a shaded resource element indicates that a DM-RS symbol is transmitted within that resource element. Note that there are multiple DM-RS ports per CDM group, which are separated using frequency-domain (and time-domain, for double-symbol DM-RS) Orthogonal Cover Codes (OCCs):
   For single-symbol DM-RS, there exist 4 and 6 orthogonal DM-RS ports (2 DM-RS ports per CDM group, separated using a length-2 frequency domain orthogonal cover code, FD-OCC) for type 1 and type 2, respectively.
   For double-symbol DM-RS, there exist 8 and 12 orthogonal DM-RS ports (4 DM-RS ports per CDM group, separated using a length-2 Frequency Domain Orthogonal Cover Code (FD-OCC) combined with a length-2 Time Domain Orthogonal Cover Code (TD-OCC)) for type 1 and type 2, respectively.
Any additional DM-RS symbols (0, 1, 2 or 3 for single-symbol DM-RS and 0 or 1 for double-symbol DM-RS) are configured by the RRC parameter DM-RS-AdditionalPosition. The position of additional DM-RS depends on the PUSCH mapping type and PUSCH duration according to a predefined table. Note that it is not possible to configure a TD-OCC over additional (i.e., noncontiguous DM-RS. FIG. 4 illustrates an example of symbol positions of DM-RS symbols in a resource block for DM-RS type 1 with additional DM-RS symbols. Specifically, FIG. 4(a) shows DM-RS symbol positions for DM-RS type 1, single symbol, with two additional DM-RS symbols, and FIG. 4(b) shows DM-RS symbol positions for DM-RS type 1, double symbol, with one additional DM-RS symbol.
The associated Phase Tracking Reference Signal (PT-RS) (if any) may be configured by the RRC parameter phase TrackingRS.
The maximum number of adjacent DM-RS symbols (1 or 2) may be configured by the RRC parameter maxLength.

If transform precoding is disabled (i.e., if the waveform is CP-OFDM), DM-RS for PUSCH can be additionally and optionally configured with respect to scrambling ID 0 and 1, configured by RRC parameters scramblingID0 and scramblingID1, respectively, which are used for generating the pseudo-random DM-RS sequence.

DM-RS ports are mapped to resource elements within one CDM group. DM-RS ports that belong to the same CDM group are separated by a length-2 FD-OCC (and a length-2 TD-OCC, for double-symbol DM-RS). In NR Rel-16, the DM-RS sequence is mapped to the following subcarriers (for DFT-S-OFDM, only DM-RS type 1 is supported):

$$k = \{ \begin{matrix}4 n + 2 {k}^{′} + Δ , & for type 1 , \\ 6 n + {k}^{′} + Δ , & for type 2.\end{matrix}$$

Here, k is the subcarrier index (which starts/ends at the first/last subcarrier within the scheduled PUSCH bandwidth), n∈{0, 1, 2, . . . }, k′∈{0,1}, and A is an offset that depends on the CDM group.

In Table 1 and Table 2, we show port-specific parameters for DM-RS type 1 and type 2. Here, w_{f}(k′), where k′∈{0,1}, is the FD-OCC and wₜ(l′), where l′=0 for single-symbol DM-RS and l′∈{0,1} for double-symbol DM-RS, is the TD-OCC. Note that DM-RS ports in different CDM groups are separated by different offsets and that DM-RS ports within the same CDM group are separated through coding.

TABLE 1
Parameters for PUSCH DM-RS configuration type 1
(reproduced from Table 6.4.1.1.3-1 of 3GPP TS 38.211).
Here, \tilde{p} denotes the DM-RS port.

| | | |
|---|---|---|
| CDM | w_{f} (k′) | wₜ (l′) |

| \tilde{p} | group λ | Δ | k′ = 0 | k′ = 1 | l′ = 0 | l′ = 1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 1 | +1 | +1 | +1 | +1 |
| 3 | 1 | 1 | +1 | −1 | +1 | +1 |
| 4 | 0 | 0 | +1 | +1 | +1 | −1 |
| 5 | 0 | 0 | +1 | −1 | +1 | −1 |
| 6 | 1 | 1 | +1 | +1 | +1 | −1 |
| 7 | 1 | 1 | +1 | −1 | +1 | −1 |

TABLE 2
Parameters for PUSCH DM-RS configuration type 2
(reproduced from Table 6.4.1.1.3-2 of 3GPP TS 38.211).
Here, \tilde{p} denotes the DM-RS port.

| | | |
|---|---|---|
| CDM | w_{f} (k′) | wₜ (l′) |

| \tilde{p} | group λ | Δ | k′ = 0 | k′ = 1 | l′ = 0 | l′ =1 |
|---|---|---|---|---|---|---|
| 0 | 0 | 0 | +1 | +1 | +1 | +1 |
| 1 | 0 | 0 | +1 | −1 | +1 | +1 |
| 2 | 1 | 2 | +1 | +1 | +1 | +1 |
| 3 | 1 | 2 | +1 | −1 | +1 | +1 |
| 4 | 2 | 4 | +1 | +1 | +1 | +1 |
| 5 | 2 | 4 | +1 | −1 | +1 | +1 |
| 6 | 0 | 0 | +1 | +1 | +1 | −1 |
| 7 | 0 | 0 | +1 | −1 | +1 | −1 |
| 8 | 1 | 2 | +1 | +1 | +1 | −1 |
| 9 | 1 | 2 | +1 | −1 | +1 | −1 |
| 10 | 2 | 4 | +1 | +1 | +1 | −1 |
| 11 | 2 | 4 | +1 | −1 | +1 | −1 |

From the transmitter's perspective, the number of DM-RS ports used for PUSCH transmission coincides with the transmission rank, i.e., one DM-RS port per transmitted layer. The DM-RS port mapping is signaled to the UE from the gNB via DCI. Tables 3 and 4 below show such an indication for DCI 0_1, CP-OFDM, single-symbol DM-RS type 1, and for transmission rank 1 and 2, respectively. Similar tables can be found in 3GPP TS 38.212 version 16.10.0 for rank 3 and 4, double-symbol DM-RS, and for DM-RS type 2. Subcarriers, which are associated with a CDM group, that are not used for DM-RS can be used for PUSCH. After layer mapping, the DM-RS and the associated PUSCH are mapped to physical antennas through precoding.

TABLE 3
Antenna ports for single-symbol DM-RS type 1, transform
precoding is disabled, rank-1 transmission (reproduced
from Table 7.3.1.1.2-8 of 3GPP 38.212 version 16.10.0).

| | Number of DM-RS CDM group(s) | DM-RS |
|---|---|---|
| Value | without data | port(s) |
| 0 | 1 | 0 |
| 1 | 1 | 1 |
| 2 | 2 | 0 |
| 3 | 2 | 1 |
| 4 | 2 | 2 |
| 5 | 2 | 3 |
| 6-7 | Reserved | Reserved |

TABLE 4
Antenna ports for single-symbol DM-RS type 1, transform
precoding is disabled, rank-2 transmission (reproduced
from Table 7.3.1.1.2-9 of 3GPP 38.212 version 16.10.0).

| | Number of DM-RS CDM group(s) | DM-RS |
|---|---|---|
| Value | without data | port(s) |
| 0 | 1 | 0, 1 |
| 1 | 2 | 0, 1 |
| 2 | 2 | 2, 3 |
| 3 | 2 | 0, 2 |
| 4-7 | Reserved | Reserved |

The training methods referred to above have been adopted in typical wireless communications standards. Its spectrum efficiency inevitably becomes worse for high-mobility scenarios due to the fact that more reference symbols are needed to track and estimate the varying channel accurately, which increases the communication overhead. This calls for need to find methods to eliminate or reduce overhead due to use of reference symbols, to achieve higher spectral efficiency for 5G-advanced and beyond.

An approach to tackle the pilot overhead is the use of differential space-time coding, which does not require periodic pilot symbols and supports the scenarios where CSI fluctuates rapidly over time. It enables noncoherent detection by encoding the information onto the signal difference between time slots. Its major issue is that one needs to concede a 3 dB SNR loss at best and a low spectrum efficiency due to the nature of the differential coding.

Semi-blind methods have been proposed to reduce pilot overheads. Semi-blind approaches first estimate the CSI roughly by using a short reference signal sequence and intend to improve the CSI by taking advantage of the data and performing joint channel and data detection. Although this approach improves the spectrum efficiency compared to coherent counterparts, transmitting a reference signal still limits the improvement on the spectrum efficiency.

Another approach estimates CSI by using second order statistics of received signals and algebraic properties of the symbol. The major problem of this method is that it is difficult to determine the phase of the channel response in the complex domain, resulting in inferior channel estimation performance. To resolve this issue, it is needed to transmit a pilot tuple or use an asymmetric constellation. This uses Orthogonal Space-Time Block Coding (OSTBC) symbols and estimates CSI from a covariance matrix of the received signal, which requires a long coherence time to obtain CSI, leading to a significant amount of latency.

Finally, some approaches superimpose pilot symbols onto data symbols on the complex domain. This enables simultaneous estimation of channel and data at the receiver. In massive MIMO scenarios, the superimposed pilot is effective in mitigating pilot contamination in both uplink and downlink. However, this method deteriorates the spectrum efficiency as the transmit power that is allocated to data symbols decreases.

Overall, the above approaches are shown to be limited [1] in terms of either channel estimation performance or spectrum efficiency, while being incompatible with the 3GPP standard signaling structure.

### SUMMARY

Examples of this disclosure may have certain advantages. For example, embodiments of this disclosure may provide a signal constellation, or related symbol sequences, that allow for reduced decoding complexity while maintaining or substantially maintaining channel estimation performance and/or symbol error rate (SER) performance.

One aspect of the present disclosure provides a method (500) of transmitting data to a network node. The method comprises selecting, based on the data to be transmitted to the network node, one of a plurality of first constellation points on a Grassmannian manifold, wherein the first constellation points comprise a plurality of groups of first constellation points, and a distance between first constellation points in each group is smaller than a distance between groups of first constellation points. The method also comprises transmitting a reference signal symbol sequence associated with the selected first constellation point to the network node.

Another aspect of the present disclosure provides a method (600) of receiving data from a network node. The method comprises receiving (602), from the network node, a reference signal symbol sequence associated with one of a plurality of first constellation points on a Grassmannian manifold, wherein the first constellation points comprise a plurality of groups of first constellation points, and a distance between first constellation points in each group is smaller than a distance between groups of first constellation points. The method also comprises determining, based on the reference signal symbol sequence, the data transmitted by the network node.

Another aspect of the present disclosure provides a method of determining a plurality of first constellation points for signal transmission. The method comprises selecting a plurality of second constellation points on a Grassmannian manifold, and mapping each second constellation point to a group of first constellation points on the Grassmannian manifold such that a distance between first constellation points in each group is smaller than a distance between groups of first constellation points.

An additional aspect of the present disclosure provides apparatus for transmitting data to a network node. The apparatus comprises a processor and a memory. The memory contains instructions executable by the processor such that the apparatus is operable to select, based on the data to be transmitted to the network node, one of a plurality of first constellation points on a Grassmannian manifold, wherein the first constellation points comprise a plurality of groups of first constellation points, and a distance between first constellation points in each group is smaller than a distance between groups of first constellation points; and transmit a reference signal symbol sequence associated with the selected first constellation point to the network node.

A further aspect of the present disclosure provides apparatus for receiving data from a network node. The apparatus comprises a processor and a memory. The memory contains instructions executable by the processor such that the apparatus is operable to receive, from the network node, a reference signal symbol sequence associated with one of a plurality of first constellation points on a Grassmannian manifold, wherein the first constellation points comprise a plurality of groups of first constellation points, and a distance between first constellation points in each group is smaller than a distance between groups of first constellation points; and determine, based on the reference signal symbol sequence, the data transmitted by the network node.

A further aspect of the present disclosure provides apparatus for determining a plurality of first constellation points for signal transmission. The apparatus comprises a processor and a memory. The memory contains instructions executable by the processor such that the apparatus is operable to select a plurality of second constellation points on a Grassmannian manifold, and map each second constellation point to a group of first constellation points on the Grassmannian manifold such that a distance between first constellation points in each group is smaller than a distance between groups of first constellation points.

A still further aspect of the present disclosure provides apparatus for transmitting data to a network node. The apparatus is configured to select, based on the data to be transmitted to the network node, one of a plurality of first constellation points on a Grassmannian manifold, wherein the first constellation points comprise a plurality of groups of first constellation points, and a distance between first constellation points in each group is smaller than a distance between groups of first constellation points; and transmit a reference signal symbol sequence associated with the selected first constellation point to the network node.

Another aspect of the present disclosure provides apparatus for receiving data from a network node. The apparatus is configured to receive, from the network node, a reference signal symbol sequence associated with one of a plurality of first constellation points on a Grassmannian manifold, wherein the first constellation points comprise a plurality of groups of first constellation points, and a distance between first constellation points in each group is smaller than a distance between groups of first constellation points; and determine, based on the reference signal symbol sequence, the data transmitted by the network node.

An additional aspect of the present disclosure provides apparatus for determining a plurality of first constellation points for signal transmission. The apparatus is configured to select a plurality of second constellation points on a Grassmannian manifold, and map each second constellation point to a group of first constellation points on the Grassmannian manifold such that a distance between first constellation points in each group is smaller than a distance between groups of first constellation points.

### BRIEF DESCRIPTION OF THE DRAWINGS

For a better understanding of examples of the present disclosure, and to show more clearly how the examples may be carried into effect, reference will now be made, by way of example only, to the following drawings in which:

FIG. 1 illustrates an example of a NR time-domain structure with 15 kHz subcarrier spacing;

FIG. 2 illustrates an example of a NR physical time-frequency resource grid;

FIG. 3 illustrates the symbol positions of DM-RS symbols in a resource block for DM-RS types 1 and 2;

FIG. 4 illustrates an example of symbol positions of DM-RS symbols in a resource block for DM-RS type 1 with additional DM-RS symbols;

FIG. 5 shows an example of normalized mean square error (NMSE) performance of different Grassmann constellations when used for data transmission;

FIG. 6 shows an example of symbol error rate (SER) performance of different Grassmann constellations when used for data transmission;

FIG. 7 shows an example of the complexity order required to decode a matrix reference signal representing a multidimensional constellation point;

FIG. 8 is a flow chart of an example of a method of transmitting data to a network node;

FIG. 9 shows an example of constellation points on a Grassmannian manifold;

FIG. 10 is a flow chart of an example of a method of receiving data from a network node;

FIG. 11 shows examples of a single symbol and a double symbol Type 1 Grassmann DM-RS;

FIG. 12 shows an example of repetition of a Grassmann based DM-RS sequence in the frequency domain;

FIG. 13 shows examples of a Grassmann based DM-RS sequence divided into groups for a DM-RS port while utilizing consecutive OFDM symbols;

FIG. 14 shows examples of use of both legacy DM-RS and DM-RS according to this disclosure;

FIG. 15 is a flow chart of an example of a method of determining a plurality of first constellation points for signal transmission;

FIG. 16 shows an example of the decoding complexity of examples of this disclosure and the state-of-the-art methods;

FIG. 17 shows an example of symbol error rate (SER) performance with respect to signal to noise ratio (SNR) of examples of this disclosure and state-of-the-art methods;

FIG. 18 shows an example of normalized mean square error (NMSE) performance with respect to SNR of embodiments of this disclosure and state-of-the-art methods;

FIG. 19 is a schematic of an example of an apparatus for transmitting data to a network node;

FIG. 20 is a schematic of an example of an apparatus for receiving data from a network node; and

FIG. 21 is a schematic of an example of an apparatus for determining a plurality of first constellation points for signal transmission.

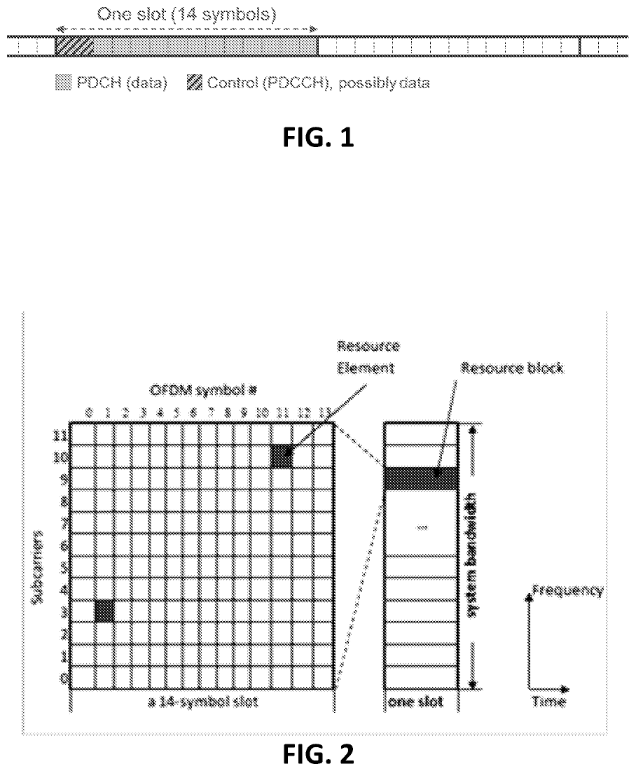

### DETAILED DESCRIPTION

The following sets forth specific details, such as particular embodiments or examples for purposes of explanation and not limitation. It will be appreciated by one skilled in the art that other examples may be employed apart from these specific details. In some instances, detailed descriptions of well-known methods, nodes, interfaces, circuits, and devices are omitted so as not obscure the description with unnecessary detail. Those skilled in the art will appreciate that the functions described may be implemented in one or more nodes using hardware circuitry (e.g. analog and/or discrete logic gates interconnected to perform a specialized function, Application Specific Integrated Circuits (ASICs), Programmable Logic Arrays (PLAs), etc.) and/or using software programs and data in conjunction with one or more digital microprocessors or general purpose computers. Nodes that communicate using the air interface also have suitable radio communications circuitry. Moreover, where appropriate the technology can additionally be considered to be embodied entirely within any form of computer-readable memory, such as solid-state memory, magnetic disk, or optical disk containing an appropriate set of computer instructions that would cause a processor to carry out the techniques described herein.

Hardware implementation may include or encompass, without limitation, digital signal processor (DSP) hardware, a reduced instruction set processor, hardware (e.g. digital or analogue) circuitry including but not limited to application specific integrated circuit(s) (ASIC) and/or field programmable gate array(s) (FPGA(s)), and (where appropriate) state machines capable of performing such functions.

Example embodiments of this disclosure may enable improvements in spectrum efficiency by replacing reference signals (e.g., DM-RS in NR) with a codeword, such as for example from a Grassmann manifold, where each codeword can convey data bits. Example embodiments may also reduce the impact of overhead from reference signals such as DM-RS. This may be particularly beneficial in networks, such as for example 5G and 6G networks, that may have very small amounts of data to transmit, and as such the overhead due to reference signal symbols may be significant. It is assumed that in the future, networks may need be adapted for transmitting smaller chunks of data, such as can be carried by just one symbol of a resource block (RB) in some examples. Therefore, it is particularly useful to reduce the impact of reference signals, such as in example methods of this disclosure that can transmit data with reference signal symbols.

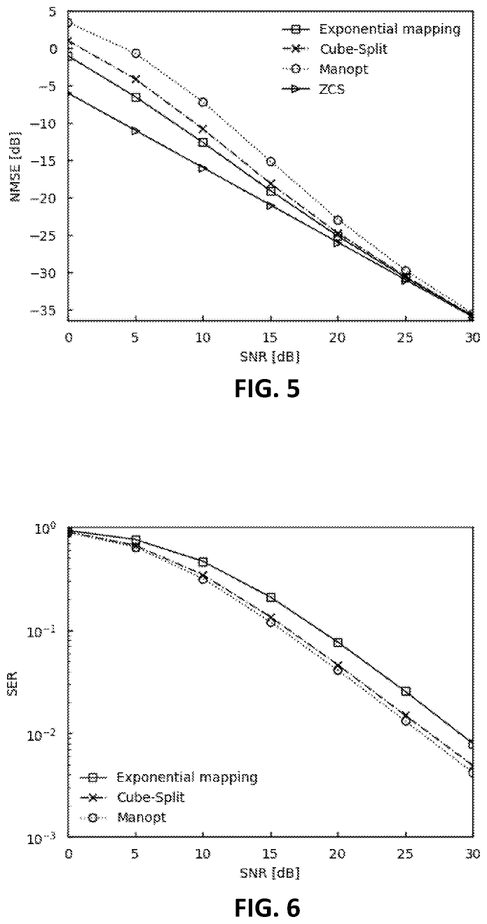

A challenge in constructing Grassmann constellations for examples of Grassmann-based reference signal and data transmission as disclosed herein is a trade-off between estimation performance of the reference signal X and the channel H. More specifically, for example, normalized mean square error (NMSE) and symbol error rate (SER) performance of different Grassmann constellations when used for data transmission are shown in FIGS. 5 and 6 respectively, where the NMSE and SER performance is shown against Signal to Noise Ration (SNR). The constellations for which performance is shown are exponential mapping, Cube-Split and ManOpt, while the NMSE performance of the Zadoff-Chu sequence (ZCS) is included as a baseline in FIG. 5. Note that the ZCS is a conventional reference signaling methodology and may not send data, unlike the Grassmann sequences used as disclosed herein; therefore, it may be regarded for example as a channel estimation performance baseline. The ManOpt constellation is a numerically optimized Grassmann constellation, for which a publicly available optimization solver “Pymanopt” was used to demonstrate its performance.

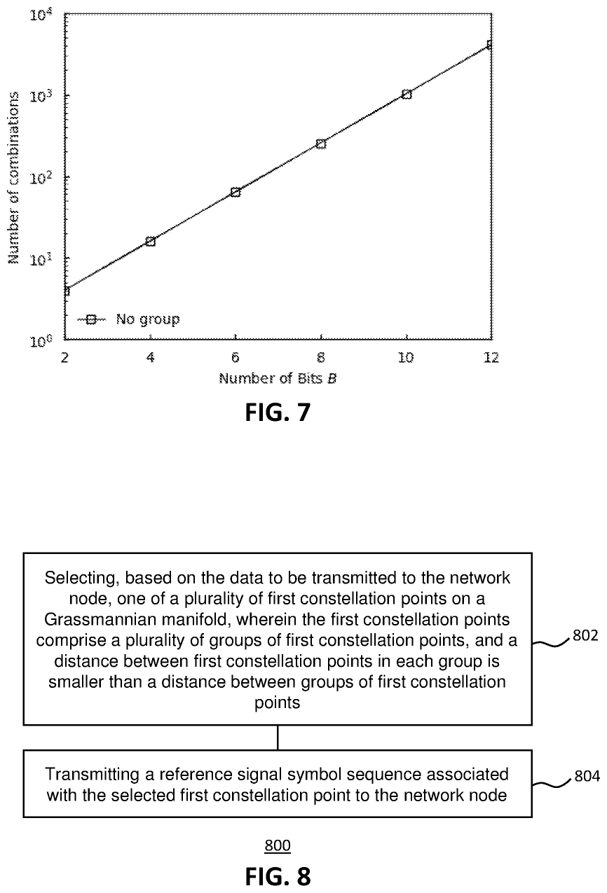

FIG. 7 shows an example of the complexity order required to decode the matrix reference signal X representing a multidimensional constellation point chosen from Grassmann constellations (e.g. exponential mapping, cube-split and ManOpt constellations as shown in FIGS. 5 and 6), against the number of bits B represented by the constellation point (or corresponding codeword or sequence of symbols). The decoding process may be for example that described in equation (2) below. As shown in FIG. 7, the complexity order required to decode the reference signal X grows exponentially with respect to the number of bits encoded by a constellation point or codeword. That is, increasing the number of bits may allow more data to be sent within a given resource block, while increasing the decoding complexity.

Comparing the SER and NMSE performance shown in FIGS. 5 and 6, it can be seen that there is a clear trade-off between the SER and NMSE. In other words, the exponential mapping is the best of the illustrated methods in terms of channel estimation performance while being the worst in terms of the SER performance. Similarly, the Cube-Split and ManOpt method are shown to be better than the exponential mapping in terms of SER at the cost of having a worse channel estimation performance. Given the above, a Grassmann constellation methodology to tackle this trade-off, i.e. to improve the channel estimation NMSE performance while maintaining SER performance, is the focus of example embodiments of this disclosure.

From the above, embodiments of this disclosure may provide for a transmitter and receiver methodology, signal constellation construction, and corresponding apparatus, that allow for signals such as data-carrying reference signaling to achieve a similar NMSE performance with minimum loss in SER compared to the state-of-the-art methods while significantly reducing the decoding complexity. For example, disclosed methodologies may provide a grouping structure in Grassmann codewords such that the decoding search space is exponentially reduced. Simulation results confirm that the decoding complexity can in some examples be approximately 10 times lower than state-of-the-art methods, while maintaining a comparable SER and NMSE performance.

FIG. 8 is a flow chart of an example of a method 800 of transmitting data to a network node. In some examples, the network node is a Radio Access Network (RAN) node, such as a base station, gNodeB, eNodeB, or similar. In such examples, the method 800 may be performed by a User Equipment (UE). Alternatively, in some examples, the network node is a UE, and the method 800 may be performed by a RAN node, such as a base station, gNodeB, eNodeB, or similar.

The method comprises, in step 802, selecting, based on the data to be transmitted to the network node, one of a plurality of first constellation points on a Grassmannian manifold, wherein the first constellation points comprise a plurality of groups of first constellation points, and a distance (e.g. Euclidian distance) between first constellation points in each group is smaller than a distance between groups of first constellation points. Next, step 804 of the method 800 comprises transmitting a reference signal symbol sequence associated with the selected first constellation point to the network node.

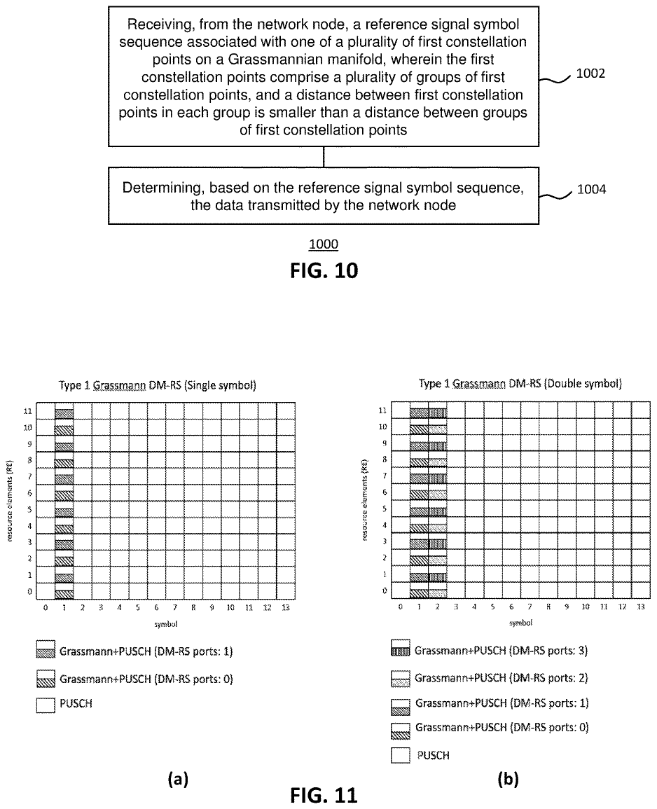

As a result of the distance between first constellation points in each group being smaller than the distance between groups of first constellation points, a receiver (e.g. demodulator, decoder etc) may exploit this feature to reduce complexity. For example, a receiver may first estimate, for a received symbol sequence, which group the symbol sequence belongs to, and then estimate which of the symbol sequences in the group has been received. Thus, the search space for estimating which symbol sequence has been received may be reduced as compared to examples where the received symbol sequence is compared to all possible symbol sequences. Further examples of methods in a receiver are described below with reference to FIG. 10.

The distance between first constellation points in each group being smaller than the distance between groups of first constellation points may allow the receiver to more reliably estimate the group that the received sequence belongs to as compared to where the constellation points are evenly spaced, for example, particularly in the presence of interference and/or noise. In some examples, the distance between first constellation points in each group is smaller than the distance between any two groups of first constellation points.

Regarding the method 800 of FIG. 8, selecting one of a plurality of first constellation points in step 802 may comprise selecting, based on the network node, one of the groups of first constellation points, and selecting, based on the data to be transmitted to the network node, one of the first constellation points in the selected group. Selecting a group based on the network node may comprise for example selecting a first group if transmitting data to a first network node, and selecting a second, different group if transmitting data to a second network node. This may in some examples enable “constellation division multiple access,” where for example a receiver may first estimate which group a received symbol sequence belongs to. If that group is associated with that receiver, it may then estimate which sequence in the group has been received and thus estimate the received data, but if the group is not associated with the receiver then the receiver may ignore the received symbol (e.g. it may be intended for a different receiver).

In other words, in some examples, each group of first constellation points may be associated with one or more respective network nodes for receiving reference signal symbol sequences associated with first constellation points in the group. The method 800 may in some examples comprise sending, to one or more first network nodes, one or more reference signal symbol sequences associated with first constellation points in a first one of the groups of first constellation points. The method 800 may also comprise sending, to one or more second network nodes, one or more reference signal symbol sequences associated with first constellation points in a second one of the groups of first constellation points. Thus, constellation division multiple access may be used for example to transmit different data to different network nodes.

In some examples, each group of first constellation points comprises a respective second constellation point of a plurality of second constellation points on the Grassmannian manifold mapped to the first constellation points in the group using a space time coding matrix. Thus, for example, a constellation comprising the second constellation points may be provided, and each of these constellation points may be mapped or translated to a respective group of first constellation points using the respective space time coding matrix. The space time coding matrix may be the same or different for each group of first constellation points. In some examples, the distance between first constellation points in each group is smaller than the distance between any two second constellation points.

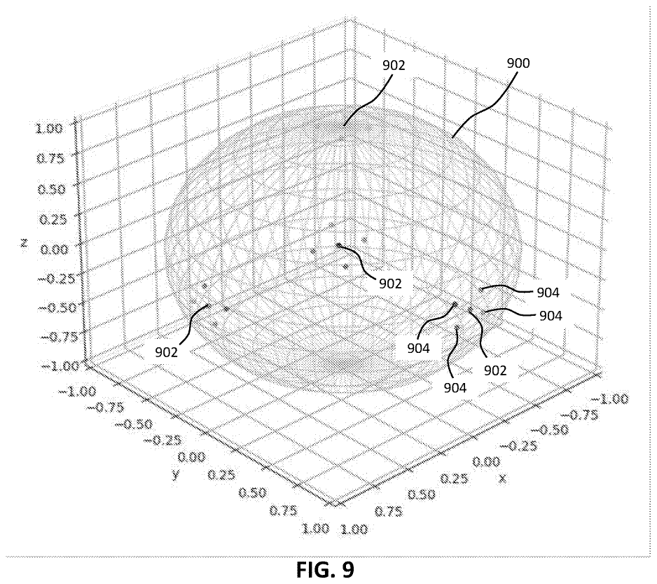

FIG. 9 shows an example of constellation points on a Grassmannian manifold 900. In this particular example, second constellation points 902 are shown on the manifold 900. Each second constellation point 902 in this example is mapped or translated to four first constellation points, and hence each group of constellation points includes four first constellation points. As an example, one of the second constellation points 902 is mapped to four first constellation points 904 comprising one group. In other examples, however, the first constellation points may be provided on the manifold 900 without the second constellation points 902, e.g. the first constellation points may be predetermined or specified without reference to the second constellation points (although in such examples the first constellation points may or may not be mapped from second constellation points).

In the example shown in FIG. 9, the Grassmann manifold 900 has three dimensions, and hence in some examples each constellation point on the manifold may be represented by three quantities. For example, a constellation point may be represented by symbols in two resource elements (REs), each RE specifying a phase and an amplitude, thus providing four quantities that can be used to represent a constellation point on the manifold. In this example, one quantity may be unused, and thus a more efficient example may use constellation points on a four dimensional manifold. More generally, a Grassmann constellation of any number of dimensions may be used, with at least an appropriate number of REs used to convey a symbol sequence that represents each constellation point. However, in particular examples, a manifold of 2n dimensions may be used, where n is the number of REs (or symbols) in the symbol sequence that represents a constellation point. Here, it is assumed that each symbol or RE may convey two items of information, e.g. a phase and an amplitude. It should be noted that in examples of this disclosure, a symbol sequence may comprise a number of two dimensional symbols, each two dimensional symbol being conveyed or transmitted in a single resource element (RE).

In some examples, each first constellation point is associated with a different value for the data. Therefore, for example, transmission of the constellation point, or a symbol sequence of reference signal symbols associated with the constellation point, conveys data through the particular constellation point that is selected. In some examples, each first constellation point within a group of first constellation points is associated with a different value for the data, whereas constellation points within different groups may be associated with the same value for the data. This may enable schemes such as constellation division multiple access, referred to above and explained further below.

In particular examples, there are n reference signal symbols (or resource elements, REs) in the sequence, and the number of reference signal symbol sequences from which the transmitted reference signal symbol sequence is selected (based on the selected constellation point) is 2^{B} with B being the number of bits encoded within the reference signal symbol sequence.

The Grassmann manifold may in some examples be at least a 2n dimension manifold, where n is the number of reference signal symbols. Thus for example each reference signal symbol (or resource element, RE) in the sequence transmitted in step 804 may convey two dimensions of the selected constellation point on the Grassmann manifold.

The reference signal symbol sequence may in some examples be repeated, such as for example in the same resource block, slot, mini-slot, subframe and/or frame. The method 800 may therefore comprise transmitting the selected reference signal symbol sequence in a plurality of first resource elements, and repeating the reference signal symbols in a plurality of second resource elements. The first plurality of resource elements may in some examples be within a first frequency range, and the second plurality of resource elements may be for example within a second frequency range non-overlapping with the first frequency range. The first and second plurality of resource elements may overlap in time, partially overlap, or be non-overlapping. The first resource elements and the second resource elements may for example be within a resource block, slot, mini-slot, subframe and/or frame.

In some examples, the transmitted reference signal symbol sequence may correspond to a first antenna port. In such examples, the method 800 may comprise, for each of one or more further antenna ports, transmitting a further reference signal symbol sequence to the network node (for example, in the same resource block, slot, mini-slot, subframe and/or frame as the reference signal symbol sequence transmitted in step 804). The method 800 may also comprise, for each of the one or more further antenna ports, selecting the further reference signal symbol sequence for transmission based on a constellation point associated with respective further data to be transmitted to the network node. This constellation point may be selected in a manner similar to that selected in step 802 above, e.g. from a plurality of constellation points on a Grassmann manifold. Alternatively, the further reference signal symbol sequence(s) may comprise a legacy reference signal for example.

The method 800 may also in some examples comprise transmitting at least one additional reference signal symbol sequence to the network node, wherein the additional reference signal symbol sequence(s) correspond to a legacy reference signal (for example, in the same resource block, slot, mini-slot, subframe and/or frame as the symbol sequence transmitted in step 802). Thus, for example, a resource block, slot, mini-slot, subframe and/or frame may include both legacy reference signal symbols and reference signal symbols that convey data.

In some examples, the transmitted reference signal symbol sequence may be a demodulation reference signal (DM-RS) or other reference signal.

FIG. 10 is a flow chart of an example of a method 1000 of receiving data from a network node. In some examples, the network node is a Radio Access Network (RAN) node, such as a base station, gNodeB, eNodeB, or similar. In such examples, the method 600 may be performed by a User Equipment (UE). Alternatively, in some examples, the network node is a UE, and the method 600 may be performed by a RAN node, such as a base station, gNodeB, eNodeB, or similar. In some examples, the network node from which the data is received performs the method 800 referred to above.

The method 1000 comprises, in step 1002, receiving, from the network node, a reference signal symbol sequence associated with one of a plurality of first constellation points on a Grassmannian manifold, wherein the first constellation points comprise a plurality of groups of first constellation points, and a distance between first constellation points in each group is smaller than a distance between groups of first constellation points. For example, a distance between first constellation points in each group is smaller than a distance between any two groups of first constellation points. Step 1004 of the method 1000 comprises determining, based on the reference signal symbol sequence, the data transmitted by the network node.

In some examples, determining the data transmitted by the network node in step 1004 comprises determining the group that includes the one of the first constellation points, and then determining which one of the first constellation points in the group is associated with the received reference signal symbol sequence. This may in some examples reduce complexity at the receiver. For example, as indicated above, the search space for estimating which symbol sequence has been received may be reduced as compared to examples where the received symbol sequence is compared to all possible symbol sequences.

In some examples, the method 1000 is performed by a node associated with one of the groups of constellation points. That is, for example, a reference signal transmitted using constellation points from a particular group may be intended only for a subset of UEs, such as one or more particular UEs. This may be referred to for example as “constellation division multiple access” as indicated above. Thus, the method 100 may in some examples comprise determining the group that includes the one of the first constellation points, and if the determined group is the group associated with the node, determining which one of the first constellation points in the group is associated with the received reference signal symbol sequence. If the determined group is not the group associated with the node, the node may ignore the received reference signal symbol sequence, or alternatively may use the received sequence as a reference signal (e.g. for channel estimation) while ignoring the data it conveys. In such examples where constellation division multiple access is employed, each first constellation point within a group of first constellation points is associated with a different value for the data, while constellation points in different groups may be associated with the same value for the data (e.g. to convey the same value to different UEs associated with different groups). Otherwise, in some examples, each first constellation point in any group may be associated with a different value for the data.

Each group of first constellation points may in some examples comprise a respective second constellation point of a plurality of second constellation points on the Grassmannian manifold mapped to the first constellation points in the group using a space time coding matrix, as suggested above. The method of claim 28, wherein the distance between first constellation points in each group is smaller than a distance between any two second constellation points.

In some examples, there may be at least 2^{B} first constellation points, with B being the number of data bits encoded by each reference signal symbol sequence. Additionally or alternatively, in some examples, the Grassmann manifold is at least a 2n dimension manifold, where n is the number of reference signal symbols in each reference signal symbol sequence.

The reference signal symbol sequence may in some examples be repeated. The method 1000 may therefore comprise receiving the reference signal symbol sequence in a plurality of first resource elements, and receiving a repeat of the reference signal symbol sequence in a plurality of second resource elements. The first plurality of resource elements are within a first frequency range, and the second plurality of resource elements may be for example within a second frequency range non-overlapping with the first frequency range. The first and second plurality of resource elements may overlap in time, partially overlap, or be non-overlapping. The first resource elements and the second resource elements may for example be within a resource block, slot, mini-slot, subframe and/or frame.

In some examples, the reference signal symbol sequence correspond to a first antenna port. In such examples, the method 1000 may comprise, for each of one or more further antenna ports, receiving a respective further reference signal symbol sequence from the network node (for example, in the same resource block, slot, mini-slot, subframe and/or frame as the plurality of reference signal symbols selected in step 502). The method 1000 may also comprise, for each of the one or more further antenna ports, determining, based on the further reference signal symbol sequence, respective further data transmitted by the network node. This may be determined in a manner similar to step 1004 of the method 1000 described above, e.g. from a plurality of symbol sequences, from a plurality of constellation points, or from a plurality of constellation points on a Grassmann manifold. Alternatively, the further reference symbols may comprise legacy reference signal symbols for example.

The method 1000 may also in some examples comprise receiving one or more additional reference signal symbol sequences from the network node, wherein the additional reference signal symbol sequence(s) correspond to a legacy reference signal (for example, in the same resource block, slot, mini-slot, subframe and/or frame as the reference signal symbol sequence received in step 1002). Thus, for example, a resource block, slot, mini-slot, subframe and/or frame may include both legacy reference signal symbols, which do not convey data, and a reference signal symbol sequence that conveys the data that is determined or estimated n step 1004 of the method 1000.

As indicated above, in examples of this disclosure a Grassmann constellation may be used to select symbols for a data-carrying DM-RS, for example in place of legacy DM-RS. A Grassmann manifold may be used to construct DM-RS symbols which can carry data on top of it compared to legacy DM-RS symbols. In some examples, the Grassmann-based DM-RS may be configured in a User Equipment by a network node (e.g. base station, eNodeB, gNodeB) through Radio Resource Control (RRC) signaling.

Particular examples based on use of a Grassmann manifold are now described, though the concepts described may also be applied to other examples that use other Grassmann-based constellations and/or symbol sequences.

Some Grassmann-based non-coherent transmission methodologies have been reported in which several multidimensional Grassmann constellations have been suggested. Despite such Grassmann constellation designs, utilizing a Grassmann constellation in place of a reference signal in 5G NR configuration has not been suggested in the prior art.

### Grassmann Manifold Based Transmission

Consider a UE with M antennas transmitting to a gNB with N antennas. Concatenating received signals over temporal length T, with T>M, the received signal model can be given by:

$$y = XH + V , \qquad ( 1 )$$

where Y∈ [symbol] is the received signal matrix, X∈ [symbol] is the transmitted matrix constructed from a T-dimensional Grassmann manifold [1], H∈ [symbol] is the effective channel matrix consisting of the precoding matrix, receiver filter, and fading channel matrix, and V∈ [symbol] is the noise matrix. Next, a possible approach to estimate the transmitted matrix X and the channel matrix H is described.

### Estimation of the Transmitted Matrix X

In order to estimate the channel matrix, the transmitted matrix X is firstly estimated, where X is one of the discrete points represented by the pre-defined MT-dimensional Grassmann manifold. Although any reasonable detection methodology can be considered to detect the transmitted matrix X, a generalized likelihood ratio test (GLRT) is presented here, which is to solve the following maximization problem:

$$\hat{X} = {arg max}_{\dot{X} ∈ 𝒳} Tr \{ {YY}^{H} \dot{X} {\dot{X}}^{H} \} , \qquad ( 2 )$$

where \hat{X} is the estimate of the transmitted matrix X and [symbol] is a set of discrete points on MT-dimensional space defined by the pre-determined Grassmann manifold. Due to the discreteness of [symbol] , digital data symbols can be encoded on each discrete point on MT-dimensional space. The difference from the digital modulation is that the discrete point of [symbol] is defined in a multidimensional space in contrast to the complex space (i.e., [symbol] ) of digital modulation schemes such as QAM or PSK.

### Estimation of the Transmitted Matrix H

Given the estimate \hat{X}, the channel matrix H can also be estimated by any channel estimation method that assumes the knowledge of matrix X. For example, with the zero-forcing method the estimate of H is given by:

$$\hat{H} = {( {\hat{X}}^{H} \hat{X} )}^{- 1} {\hat{X}}^{H} Y . \qquad ( 3 )$$

Alternatively, assuming availability of the covariance matrix of the receiver noise Cov(V), the estimate of H with the minimum mean square error (MMSE) estimator is given by:

$$\hat{H} = {( {\hat{X}}^{H} \hat{X} + Cov ( V ) )}^{- 1} {\hat{X}}^{H} Y . \qquad ( 4 )$$

In a similar embodiment, a joint detection of the matrix H and matrix X can be considered.

In some examples, a method to apply Grassmann manifold-based DM-RS for demodulation of transmitted symbols in a NR system is provided. Though in the following example the method is described for an uplink NR transmission from a User Equipment (UE) to a gNodeB (gNB), the method (and other methods of this disclosure) can be applied to any general wireless communication system, including uplink, downlink, sidelink, peer-to-peer, and others, and between any two network nodes. Also, in this example, PUSCH data symbols are sent using a DM-RS, though in other examples any data may be sent using any reference signal or other signal.

Unlike the legacy DM-RS, data such as PUSCH data symbols in examples of this disclosure are superimposed on to the Grassmann based DM-RS, resulting in higher spectral efficiency. Accordingly, consider a User Equipment (UE) with υ DM-RS antennas ports serving the gNB. Considering a DM-RS sequence for a port is spread over Nₛ subcarriers, the received signal for the DM-RS ports transmitting over same OFDM symbol but different subcarriers, given by υ̅≤υ, can be given by:

$${Y}_{u} = {X}_{u} {H}_{u} + {V}_{u} , \qquad ( 5 )$$

where Yᵤ∈ [symbol] is the received signal matrix, Xᵤ∈ [symbol] is block-diagonal matrix such that, Xᵤ=blkdiag(x₁, . . . , x₀), where xᵢ∈ [symbol] is a Nₛ-dimensional Grassmann manifold [1] transmitted through i^{th} DM-RS port, Hᵤ∈ [symbol] is the effective channel matrix incorporating the precoding matrix, receiver filter, and the propagation channel matrix, and Vᵤ∈ [symbol] is the noise matrix. At the gNB, the transmitted matrix and the channel matrix can be estimated with methodologies similar to that described above. Note that though the Grassmann manifold is used to describe the joint pilot and data transmission in this example, the general principle applies to any multi-dimensional constellation capable of carrying data symbols (PUSCH/PDSCH) on top of it.

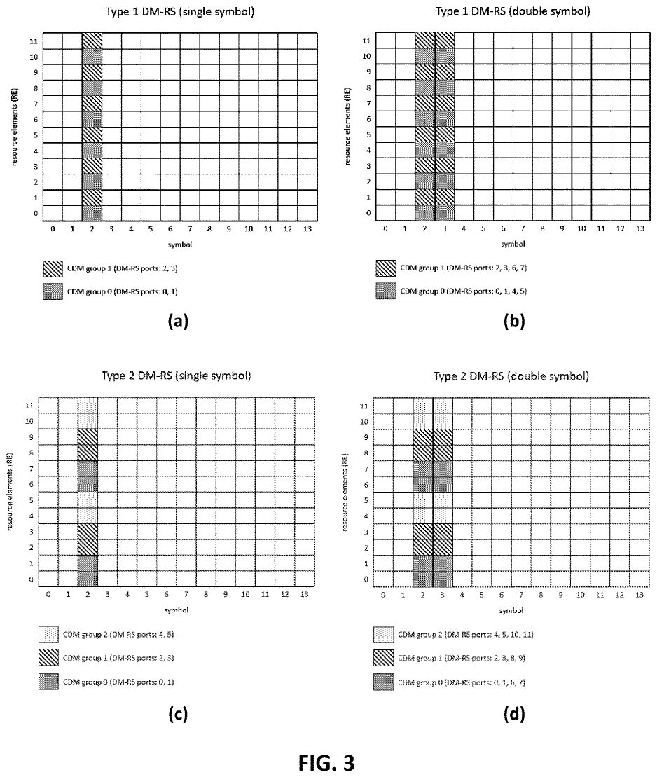

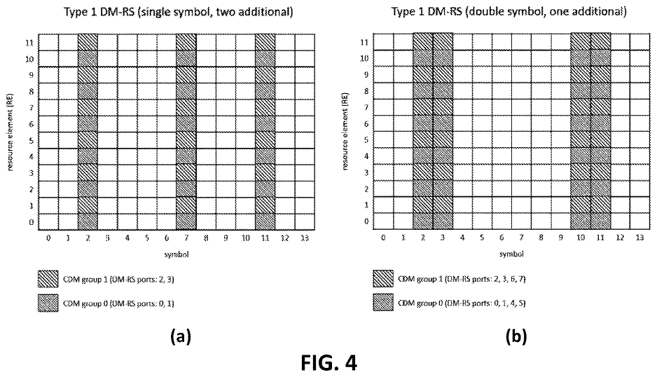

In an example, the Grassmann sequence of each port with length Nₛ can be mapped to resource elements (REs) in a manner similar to legacy Type 1 DM-RS mapping described above, giving two DM-RS ports. Furthermore, in the time-domain, DM-RS can be single symbol or double symbol as shown in FIG. 3(a)-(d). Accordingly, two and four Grassmann based DM-RS ports are possible with one and two-time domain DM-RS symbol, respectively, considering υ̅=2, as shown in FIG. 11. Specifically, FIG. 11(a) shows an example of a single symbol Type 1 Grassmann DM-RS, and FIG. 11(b) shows an example of a double symbol Type 1 Grassmann DM-RS. In a related example, the Grassmann based DM-RS can be mapped to REs in a Type 2 manner as shown in FIGS. 3(c) and (d) for legacy DM-RS. Note that the Grassmann based DM-RS can be configured with arrangements other that Type 1 and 2, since they can carry PUSCH on top of them.

Though in the above examples, the DM-RS ports per frequency and time resource, i.e., the same subcarriers and time resources (e.g. the same resource element(s)), is limited to one, in some examples code division multiplexing (CDM) using orthogonal cover codes (OCCs) can be mapped on to the Grassmann based DM-RS to transmit more than one DM-RS port using same frequency and time resources in some examples. In another example, where the DM-RS is double symbol such as Type 2 referred to above, one OFDM symbol of the double symbol may be a legacy DM-RS while the other OFDM symbol can be a data-carrying DM-RS according to the present disclosure, such as for example a Grassmann based DM-RS.

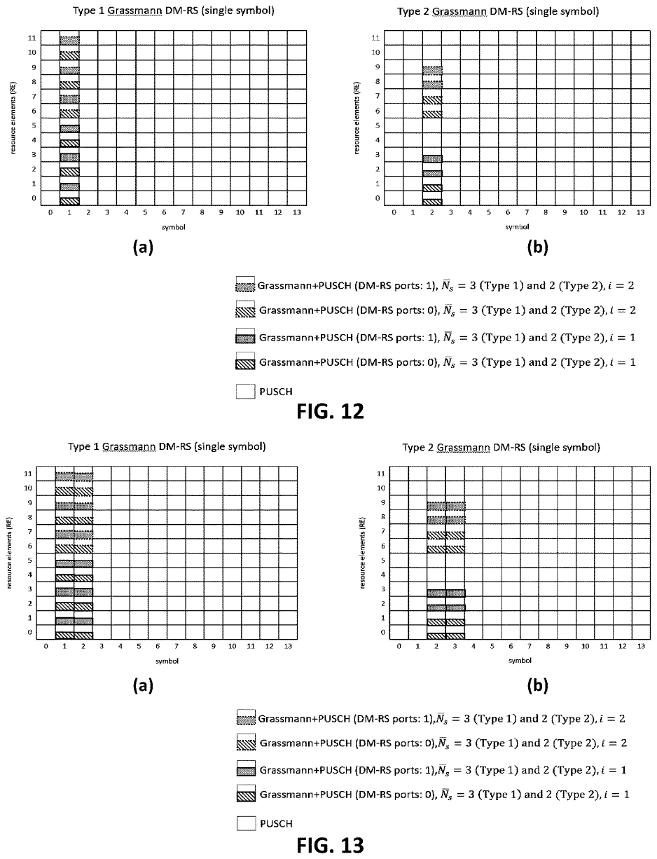

In some examples of this disclosure, the accuracy of channel estimation depends on the frequency selectivity of the channel. For a frequency-flat channel, the channel across the allocated bandwidth is equivalent giving an accurate channel estimation. However, with an increase in the frequency selectivity, the accuracy of the channel estimation may degrade in some examples for a Grassmann based DM-RS. Furthermore, the decoding complexity may be proportional to the Grassmann based DM-RS sequence length Nₛ. Hence, in some examples, Nₛ can be divided into smaller equal lengths N̅ₛ, such that N̅ₛI=Nₛ, I∈ [symbol] . Accordingly, a shorter N̅ₛ Grassmann based DM-RS sequence is repeated I times to cover Nₛ subcarriers, as suggested above with reference to the method 500 or 600. This may for example allow estimation over a smaller bandwidth with lower frequency selectivity while having a lower complexity for each of the smaller sequences. As an example, the above embodiment is illustrated in FIG. 12, which shows an example of repetition of a Grassmann based DM-RS sequence in the frequency domain. Specifically, FIG. 12(a) shows an example of the Grassmann based DM-RS sequence divided into groups for a DM-RS port, with each group occupying N̅ₛ=3 subcarriers for Type 1 arrangement, and FIG. 12(b) shows N̅ₛ=2 subcarriers for Type 2 arrangement.

In a related example, if more accurate channel estimation is needed, a Grassmann based DM-RS sequence can be sent over N̅ₛ subcarriers and two or more consecutive OFDM symbols, resulting in modification of Yᵤ∈ [symbol] and:

$${X}_{u} = ( \begin{matrix}\begin{matrix}\begin{matrix}blkdiag ( {x}_{1}^{1} , … , {x}_{\overline{υ}}^{1} ) \\ blkdiag ( {x}_{1}^{2} , … , {x}_{\overline{υ}}^{2} )\end{matrix} \\ ⋮\end{matrix} \\ blkdiag ( {x}_{1}^{T} , … , {x}_{\overline{υ}}^{T} )\end{matrix} ) , \qquad ( 6 )$$

where T is the number of consecutive OFDM symbols and

$${x}_{\overline{υ}}^{t} ∈ {ℂ}^{{N}_{s} \times 1}$$

Is a Nₛ-dimensional Grassmann manifold [1] transmitted through i^{th} DM-RS port at t^{th} OFDM symbol. This can allow more accurate channel estimation of a high frequency selective channel by taking advantage of time domain. An example of this is illustrated in FIG. 13, where the Grassmann based DM-RS sequence is divided into groups for a DM-RS port while utilizing T=2 consecutive OFDM symbols.

Specifically, FIG. 13(a) shows an example of a single symbol Type 1 Grassmann DM-RS, and FIG. 13(b) shows an example of a single symbol Type 2 Grassmann DM-RS. This example relates to front-loaded PUSCH (i.e., PUSCH mapping type A) of duration 14 symbols. The Grassmann based DM-RS sequence is divided into groups for a DM-RS port, where each group occupies N̅ₛ=3 subcarriers and N̅ₛ=2 subcarriers for Type 1 and Type 2 kind of arrangement, respectively. The figures show two such groups, i.e., i=1, 2, for a resource block.

The frequency and time domain starting positions of DM-RS according to this disclosure, such as for example a Grassmann based DM-RS or any other example of a data-carrying DM-RS, can follow the configuration similar to legacy DM-RS as described above. In low-Doppler scenarios, similar to legacy DM-RS, one Grassmann based DM-RS symbol may be sufficient, whereas, in high-Doppler scenarios, additional Grassmann based DM-RS symbols may be useful or needed in some examples.

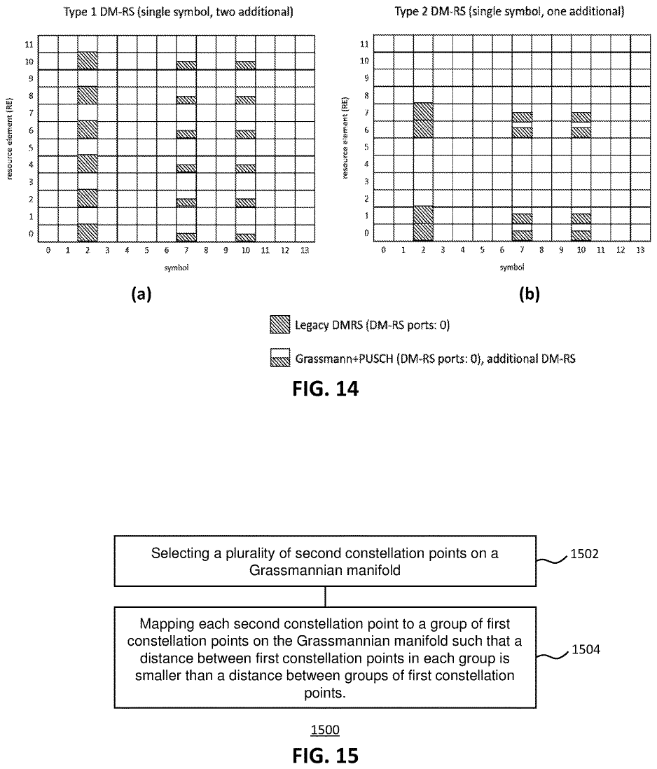

While legacy DM-RS can have the advantage of higher channel estimation accuracy and low decoding complexity in some examples, the DM-RS according to this disclosure (e.g. Grassmann based DM-RS) may impart additional spectral efficiency by superimposing PUSCH onto the Grassmann based DM-RS sequence. Accordingly, in some examples, both legacy DM-RS and DM-RS according to this disclosure can be used (e.g. in a resource block, slot, mini-slot, subframe and/or frame) to achieve advantages of both the legacy DM-RS and the DM-RS according to this disclosure. For example, in a high doppler scenario, a first DM-RS symbol in a resource block can be a legacy DM-RS, and a subsequent DM-RS can be a DM-RS according to this disclosure, such as for example Grassmann based DM-RS. An example is shown in FIG. 14. Specifically, FIG. 14(a) shows an example where one additional DM-RS position is configured for Type 1, and FIG. 14(b) shows an example where one additional DM-RS position is configured for Type 2, for a single symbol DM-RS. This example relates to front-loaded PUSCH (i.e., PUSCH mapping type A) of duration 14 symbols. The first DM-RS symbols use the legacy sequence, where the two additional DM-RS symbols in the slot use Grassmann based DM-RS.

In some examples, the use of either or both legacy DM-RS and/or DM-RS according to this disclosure can be signaled to a network node, such as a UE, by another network node, such as a gNB. This may be done for example through higher layer RRC signaling by including additional information elements in the DM-RS-config parameter structure (discussed in Section 2.1.2.1). Examples of additional parameters may include one or more of:
‘DM-RS-Sequence’ can signal the use of legacy DM-RS, DM-RS according to this disclosure, or both,
‘DM-RS-AdditionalSequence’ signals a bit sequence equal to number of DM-RS symbols in a slot to indicate either the use of legacy DMRS or DM-RS according to this disclosure in each DM-RS symbol position, where position of legacy DM-RS and/or DM-RS according to this disclosure can be signaled by the gNB through RRC connection using DM-RS-AdditionalPosition information element in DM-RS-config parameter structure.

In a related example, where Phase Tracking Reference Signal (PT-RS) is configured in a slot, the PT-RS can be signaled to occupy the subcarriers and OFDM symbols such that they do not overlap with the DM-RS (e.g. DM-RS according to this disclosure such as a Grassmann based DM-RS) if used in the slot. Alternatively, the DM-RS can be configured not to overlap with the PT-RS REs.

The following describes particular example embodiments for decoding complexity reduction via a grouping-structured Grassmann constellation for data carrying reference signaling, as in the methods 800 and 1000 described above. Such examples may mitigate decoding complexity while keeping a comparable SER and NMSE performance against the state-of-the-art methods.

Define [symbol] ={E₁, E₂, . . . , E_{K}} as a set of K different Grassmann constellation points, while [symbol] ={C₁, C₂, . . . , C_{L}} is a set of L different space time coding matrices. Following the same notation as in the system model described above, each Grassmann constellation point represented by Eᵢ is a T times M matrix, i.e., Eᵢ∈ [symbol] , and each space time code matrix Cⱼ is a (T−M) times M matrix, i.e., Cⱼ∈ [symbol] .

Example steps to construct the proposed grouped Grassmann codewords or constellation points are disclosed. Each Grassmann constellation point Eᵢ may be regarded a unique basis matrix to be used to map space time coding matrices, resulting in a nested structure that can be leveraged to reduce the overall decoding search space. Thus each Grassmann constellation point Eᵢ may in some examples correspond to the second constellation point described above.

An example method of determining a plurality of first constellation points for signal (or data) transmission includes the following steps:
Pick up i-th Grassmann constellation matrix Eᵢ (e.g. matrix of second constellation points) with i∈{1, 2, . . . , K} and compute its orthogonal matrix E_{i⊥}∈ [symbol] such that

$${E}_{i}^{H} {E}_{i ⊥} = {0}_{M , ( T - M )} and {E}_{i ⊥}^{H} {E}_{i ⊥} = {I}_{( T - M )} ;$$

Define a matrix Q_{E}_{ᵢ}∈ [symbol] such that Q_{E}_{ᵢ}≙[Eᵢ E_{i⊥}];
Define the i-th group as [symbol] such that [symbol] ={Xᵢ₁, . . . , X_{iL}} where Xᵢⱼ with j∈{1, 2, . . . , L} represents the j-th constellation point (e.g. first constellation point referred to above) belonging to the i-th group. Xᵢⱼ can be obtained by encoding space time coding matrix Cⱼ with the basis matrix Eᵢ. In an embodiment, Xᵢⱼ can be obtained by the following equation:

$${X}_{ij} = {Q}_{{E}_{i}} exp ( α ( \begin{matrix}{0}_{( T - M ) \times ( T - M )} & {C}_{j} \\ - {C}_{j}^{H} & {0}_{M \times M}\end{matrix} ) ) [ \begin{matrix}{I}_{M} \\ {0}_{T - M \times M}\end{matrix} ]$$

where exp(⋅) denotes the matrix exponential and a is a tunable parameter. Thus this method may be used for example to map second constellation points 902 in FIG. 9 to first constellation points 904.
Define [symbol] as a set of the resultant grouped Grassmann constellation matrices such that [symbol] ={ [symbol] , [symbol] , . . . , [symbol] }.

In some examples, the space time code matrices [symbol] can be either any of the state-of-the-art Grassmann constellations shown in [1,2] or a set of matrices numerically optimized so as to optimize a certain criterion (e.g. Chordal distance). In another example, the space time code matrices [symbol] can be a set of orthogonal matrices.

FIG. 15 is a flow chart of an example of a method 1500 of determining a plurality of first constellation points for signal transmission. The method 1500 comprises, in step 1502, selecting a plurality of second constellation points on a Grassmannian manifold. Step 1504 of the method 1500 comprises mapping each second constellation point to a group of first constellation points on the Grassmannian manifold such that a distance between first constellation points in each group is smaller than a distance between groups of first constellation points.

In some examples, the method 1500 comprises sending information identifying the plurality of first constellation points to a transmitter for transmitting one or more reference signal symbol sequences associated with one of more of the first constellation points. Additionally or alternatively, the method 1500 may for example comprise sending information identifying the plurality of reference signal symbol sequences to a receiver for receiving one or more reference signal symbol sequences associated with one of more of the first constellation points.

The method 1500 may also comprise transmitting one or more reference signal symbol sequences associated with one of more of the first constellation points, and/or receiving one or more reference signal symbol sequences associated with one of more of the first constellation points.

A distance between first constellation points in each group is smaller in some examples than a distance between any two groups of first constellation points. Additionally or alternatively, for example, the distance between first constellation points in each group is smaller than a distance between any two second constellation points.

The following provides an example of how to use the grouped structure of the Grassmann constellation points at the receiver in order to reduce the decoding complexity. To this end, a 2-stage decoding process, of group estimation and codeword estimation, can be used to decode this constellation. The example method includes the following steps:
Denoising: As a preprocessing step, the received signal Y is denoised. For example, calculate the top-M left singular vectors of Y and obtain rough estimate U=[u₁, . . . u_{M}], where uₘ is the m-th largest left singular vector of Y.
Group estimation: Estimate which group that the transmitted reference signal X belongs to. To this purpose, the GLRT can be used as an example:

$$\text{?} = arg {max}_{i ∈ \{ 1 , … , K \}} Tr \{ {UU}^{H} {E}_{i} {E}_{i}^{H} \}$$

where the search space is [symbol] (i.e., K candidates).
Codeword estimation: Estimate which constellation point within the estimated group was transmitted. For instance, the following GLRT can be used:

$$\hat{X} = arg {max}_{X ∈ \hat{{𝒢}_{i}}} Tr \{ {UU}^{H} {XX}^{H} \}$$

where the search space now is [symbol] (i.e., L candidates).

Comparing equation (2) above, describing the state-of-the-art decoding process, and the above 2-stage decoding process, equation (2) needs to test KL different candidates to estimate the received codeword, unlike the above 2-stage decoding process where the number of required tests reduces to K+L. In a particular example, the state-of-the-art methods need to test 2⁸=256 candidates to recover 8 encoded bits, while the disclosed methodologies require testing only 32 candidates (i.e., K=16 and L=16) to recover 8 encoded bits, which is an 8 times complexity reduction compared to the state-of-the-art. Notice that K and L are parameters that can in some examples be set by choosing the desired size of the sets ε and [symbol] .

In some examples, the KL codewords resulting from K groups each with L constellation points are computed offline and signaled between the transmitter and receiver prior to the channel estimation and data communication. In other examples, the KL codewords and the corresponding grouping information may be provided in specification text, and/or they may be agreed explicitly via bilateral vendor agreements. For example, in 5G/6G communication for downlink (DL), the KL codewords and the corresponding grouping information can be part of the 3GPP specification and/or agreed explicitly via bilateral vendor agreements, where the KL codewords are computed by either of the transmitter or receiver vendor or jointly by vendors. The gNB can in some examples signal the use of such a constellation in the reference signal (e.g. DMRS) through Radio Resource Control (RRC) signaling or

Downlink Control Information (DCI), or other suitable means of informing the transmitter and/or receiver of the particular constellation used.

In some examples, the K Grassmann constellation groups can be assigned to (or associated with) ≤K different receivers in a multiple receiver transmission, such as in “constellation division multiple access” as referred to above. The assignments of groups to UE(s) may for example be signaled between the transmitter and receivers prior to the channel estimation and data communication. For example, when the transmitter is scheduled to transmit to R≤K receivers, each of the (R−1) receivers can be assigned └K/R┘ Grassmann constellation group(s), with the R-th receiver assigned with K−R└K/R┘ group(s). While dividing the K groups among the R receivers may decrease the number of information bits that can be transmitted with the Grassmann constellation, it allows simultaneous transmission of information bits to R receivers, thus achieving a constellation division multiple access within the reference signal symbols. Furthermore, in some examples, since the constellation points assigned to each receiver are orthogonal to each other (constellation points belong to different groups), this can avoid inter-receiver interference for channel estimation, thereby for example aiding the subsequent legacy multiple-access data-only transmission among the receivers. In a related example, the transmitter can assign and signal to the receivers the corresponding Grassmann constellation group(s) that is/are used for joint data and reference signal transmission. For example, in 5G/6G communication, where the transmitter and receivers are informed of all the KL codepoints (according to the embodiment above), the gNB can further signal one or more group IDs (each representing one Grassmann constellation group) to each receiver through RRC signaling or DCI.

The following illustrates the performance of an example of the disclosed grouped Grassmann constellation methodologies for data-carrying reference signaling via Grassmann constellations. The presented results can, however, be extended to other scenarios and parameters, and the disclosed methodologies may not be limited to the case simulated herein.

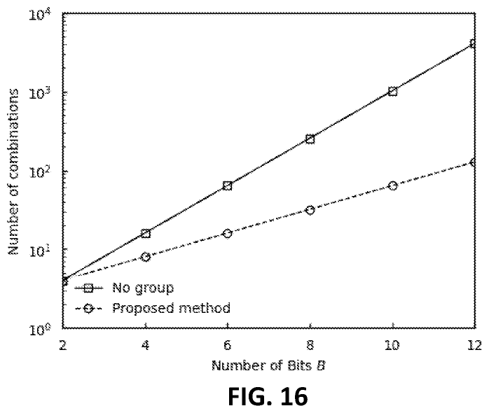

As indicated above, examples of this disclosure may allow reduction of decoding complexity while maintaining a comparable performance against the state-of-the-art methods. FIG. 16 shows an example of the decoding complexity of examples of this disclosure, which use grouped Grassmann constellation points, and the state-of-the-art methods. In FIG. 16, it is can be seen that that embodiments of this disclosure can significantly reduce the complexity order in comparison with state-of-the-art methods. As the number of bits encoded grows, the complexity reduction gain increases (approximately more than 10 times reduction in case of 8 bits or larger).

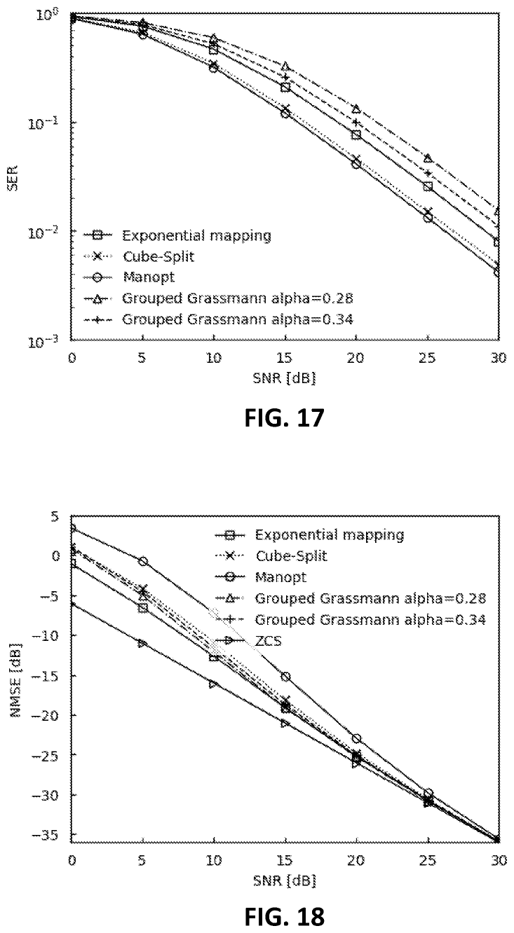

Examples of this disclosure can also provide a comparable symbol error rate (BER) and normalized mean square error (NMSE) performance against state-of-the-art methods, despite the large reduction in decoding complexity. FIG. 17 shows an example of SER performance of examples of this disclosure (referred to as “Grouped Grassmann” in FIG. 17) against the state-of-the-art methods, where M=1, T=4, B=8 are considered as system parameters and space-time coding matrices is set to

$${C}_{j} = {\frac{1}{‖ {[ 1 {s}_{1} {s}_{2} ]}^{T} ‖} [ 1 {s}_{1} {s}_{2} ]}^{T}$$

with s₁, s₂∈Gray-coded QPSK. In addition, FIG. 18 shows an example of NMSE performance with respect to SNR of embodiments of this disclosure and state-of-the-art methods. As shown in FIGS. 17 and 18, the disclosed methodologies can offer a similar SER and NMSE performance with respect to the state-of-the-art methods, where the parameter a is shown to be able to further optimize the performance of embodiments of this disclosure.

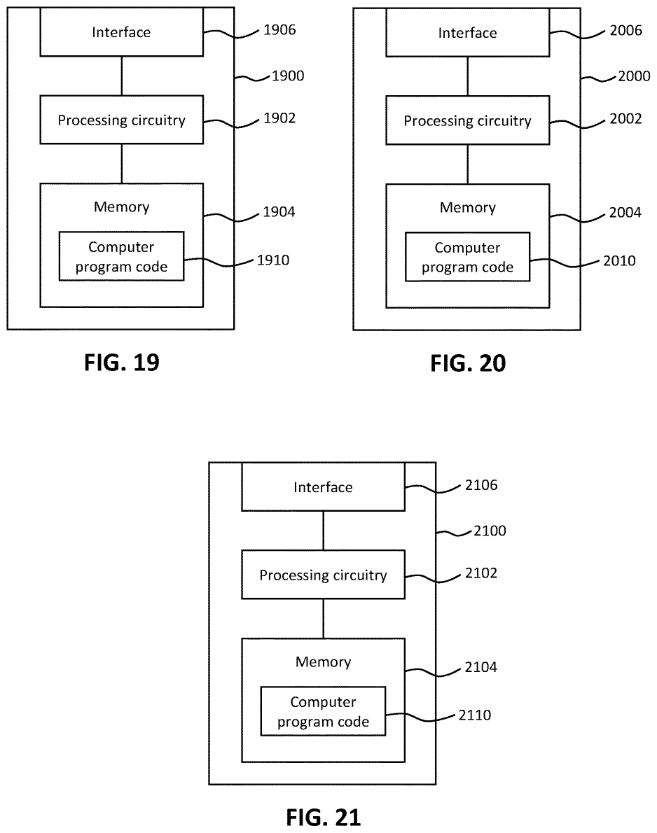

FIG. 19 is a schematic of an example of an apparatus 1900 for transmitting data to a network node. The apparatus 1900 comprises processing circuitry 1902 (e.g. one or more processors) and a memory 1904 in communication with the processing circuitry 1902. The memory 1904 contains instructions, such as computer program code 1910, executable by the processing circuitry 1902. The apparatus 1900 also comprises an interface 1906 in communication with the processing circuitry 1902. Although the interface 1906, processing circuitry 1902 and memory 1904 are shown connected in series, these may alternatively be interconnected in any other way, for example via a bus.

In one embodiment, the memory 1904 contains instructions executable by the processing circuitry 1902 such that the apparatus 1900 is operable/configured to select, based on the data to be transmitted to the network node, one of a plurality of first constellation points on a Grassmannian manifold, wherein the first constellation points comprise a plurality of groups of first constellation points, and a distance between first constellation points in each group is smaller than a distance between groups of first constellation points; and transmit a reference signal symbol sequence associated with the selected first constellation point to the network node. In some examples, the apparatus 1900 is operable/configured to carry out the method 800 described above with reference to FIG. 8.

FIG. 20 is a schematic of an example of an apparatus 2000 for receiving data from a network node. The apparatus 2000 comprises processing circuitry 2002 (e.g. one or more processors) and a memory 2004 in communication with the processing circuitry 2002. The memory 2004 contains instructions, such as computer program code 2010, executable by the processing circuitry 2002. The apparatus 2000 also comprises an interface 2006 in communication with the processing circuitry 2002. Although the interface 2006, processing circuitry 2002 and memory 2004 are shown connected in series, these may alternatively be interconnected in any other way, for example via a bus.

In one embodiment, the memory 2004 contains instructions executable by the processing circuitry 2002 such that the apparatus 2000 is operable/configured to receive, from the network node, a reference signal symbol sequence associated with one of a plurality of first constellation points on a Grassmannian manifold, wherein the first constellation points comprise a plurality of groups of first constellation points, and a distance between first constellation points in each group is smaller than a distance between groups of first constellation points; and determine, based on the reference signal symbol sequence, the data transmitted by the network node. In some examples, the apparatus 2000 is operable/configured to carry out the method 1000 described above with reference to FIG. 10.

FIG. 21 is a schematic of an example of an apparatus 2100 for determining a plurality of first constellation points for signal transmission. The apparatus 2100 comprises processing circuitry 2102 (e.g. one or more processors) and a memory 2104 in communication with the processing circuitry 2102. The memory 2104 contains instructions, such as computer program code 2110, executable by the processing circuitry 2102. The apparatus 2100 also comprises an interface 2106 in communication with the processing circuitry 2102. Although the interface 2106, processing circuitry 2102 and memory 2104 are shown connected in series, these may alternatively be interconnected in any other way, for example via a bus.

In one embodiment, the memory 2104 contains instructions executable by the processing circuitry 2102 such that the apparatus 2100 is operable/configured to select a plurality of second constellation points on a Grassmannian manifold, and map each second constellation point to a group of first constellation points on the Grassmannian manifold such that a distance between first constellation points in each group is smaller than a distance between groups of first constellation points. In some examples, the apparatus 2100 is operable/configured to carry out the method 1500 described above with reference to FIG. 15.

It should be noted that the above-mentioned examples illustrate rather than limit the invention, and that those skilled in the art will be able to design many alternative examples without departing from the scope of the appended statements. The word “comprising” does not exclude the presence of elements or steps other than those listed in a claim, “a” or “an” does not exclude a plurality, and a single processor or other unit may fulfil the functions of several units recited in the statements below. Where the terms, “first”, “second” etc. are used they are to be understood merely as labels for the convenient identification of a particular feature. In particular, they are not to be interpreted as describing the first or the second feature of a plurality of such features (i.e., the first or second of such features to occur in time or space) unless explicitly stated otherwise. Steps in the methods disclosed herein may be carried out in any order unless expressly otherwise stated. Any reference signs in the statements shall not be construed so as to limit their scope.

### REFERENCES

1. I. Kammoun and J. C. Belfiore, “A new family of Grassmann space-time codes for non-coherent MIMO systems,” IEEE Communications Letters, vol. 7, no. 11, pp. 528-530, November 2003
2. K. H. Ngo, A. Decurninge, M. Guillaud, and S. Yang, “Transmitter and receiver communication apparatus for non-coherent communication”, U.S. Pat. No. 11,258,649B2, February 2022

1-67. (canceled)

68. A method of transmitting data to a network node, the method comprising:
selecting, based on the data to be transmitted to the network node, one of a plurality of first constellation points on a Grassmannian manifold, wherein the first constellation points comprise a plurality of groups of first constellation points, and a distance between first constellation points in each group is smaller than a distance between groups of first constellation points; and
transmitting a reference signal symbol sequence associated with the selected first constellation point to the network node.

69. The method of claim 68, wherein selecting one of a plurality of first constellation points comprises:
selecting, based on the network node, one of the groups of first constellation points; and
selecting, based on the data to be transmitted to the network node, one of the first constellation points in the selected group.

70. The method of claim 68, wherein selecting one of one of the first constellation points comprises selecting a first constellation point from 2\hat{ }B first constellation points with B being the number of data bits encoded by each first constellation point and/or the reference signal symbol sequence.

71. The method of claim 68, wherein the Grassmann manifold is at least a 2n dimension manifold, where n is the number of reference signal symbols in the reference signal symbol sequence.

72. The method of claim 68, wherein the reference signal symbol sequence is a pilot signal or a demodulation reference signal (DM-RS).

73. A method of receiving data from a network node, the method comprising:
receiving, from the network node, a reference signal symbol sequence associated with one of a plurality of first constellation points on a Grassmannian manifold, wherein the first constellation points comprise a plurality of groups of first constellation points, and a distance between first constellation points in each group is smaller than a distance between groups of first constellation points; and
determining, based on the reference signal symbol sequence, the data transmitted by the network node.

74. The method of claim 73, wherein determining the data transmitted by the network node comprises:
determining the group that includes the one of the first constellation points; and
determining which one of the first constellation points in the group is associated with the received reference signal symbol sequence.

75. The method of claim 73, wherein each group of first constellation points comprises respective a second constellation point of a plurality of second constellation points on the Grassmannian manifold mapped to the first constellation points in the group using a space time coding matrix.

76. The method of claim 73, wherein there are 2\hat{ }B first constellation points with B being the number of data bits encoded by each first constellation point and/or the reference signal symbol sequence.

77. The method of claim 73, wherein the Grassmann manifold is at least a 2n dimension manifold, where n is the number of reference signal symbols in the reference signal symbol sequence.

78. The method of claim 73, wherein the reference signal symbol sequence is a pilot signal or a demodulation reference signal (DM-RS).

79. An apparatus for transmitting data to a network node, the apparatus comprising:
processing circuitry; and
memory, the memory containing instructions executable by the processing circuitry, wherein the apparatus is configured to perform a process comprising:
selecting, based on the data to be transmitted to the network node, one of a plurality of first constellation points on a Grassmannian manifold, wherein the first constellation points comprise a plurality of groups of first constellation points, and a distance between first constellation points in each group is smaller than a distance between groups of first constellation points; and
transmitting a reference signal symbol sequence associated with the selected first constellation point to the network node.

80. The apparatus of claim 79, wherein selecting one of a plurality of first constellation points comprises:
selecting, based on the network node, one of the groups of first constellation points; and
selecting, based on the data to be transmitted to the network node, one of the first constellation points in the selected group.

81. The apparatus of claim 79, wherein selecting one of one of the first constellation points comprises selecting a first constellation point from 2\hat{ }B first constellation points with B being the number of data bits encoded by each first constellation point and/or the reference signal symbol sequence.

82. The apparatus of claim 79, wherein the Grassmann manifold is at least a 2n dimension manifold, where n is the number of reference signal symbols in the reference signal symbol sequence.

83. An apparatus for receiving data from a network node, the apparatus comprising:
processing circuitry; and
memory, the memory containing instructions executable by the processing circuitry, wherein the apparatus is configured to perform a process comprising:
receiving, from the network node, a reference signal symbol sequence associated with one of a plurality of first constellation points on a Grassmannian manifold, wherein the first constellation points comprise a plurality of groups of first constellation points, and a distance between first constellation points in each group is smaller than a distance between groups of first constellation points; and
determining, based on the reference signal symbol sequence, the data transmitted by the network node.

84. The apparatus of claim 83, wherein determining the data transmitted by the network node comprises:
determining the group that includes the one of the first constellation points; and
determining which one of the first constellation points in the group is associated with the received reference signal symbol sequence.

85. The apparatus of claim 83, wherein each group of first constellation points comprises respective a second constellation point of a plurality of second constellation points on the Grassmannian manifold mapped to the first constellation points in the group using a space time coding matrix.

86. The apparatus of claim 83, wherein there are 2\hat{ }B first constellation points with B being the number of data bits encoded by each first constellation point and/or the reference signal symbol sequence.

87. The apparatus of claim 83, wherein the Grassmann manifold is at least a 2n dimension manifold, where n is the number of reference signal symbols in the reference signal symbol sequence.
